(19) United States
(12) Patent Application Publication
(10) Pub. No.: US 2025/0326448 A1
(43) Pub. Date: Oct. 23, 2025

(54) A LOAD MOVING APPARATUS

(71) Applicant: M-MOVER HOLDINGS LIMITED, Ashbourne, Derbyshire (GB)

(72) Inventors: Andrew OWEN, Ashbourne, Derbyshire (GB); James JONES, Ashbourne, Derbyshire (GB); Stephen ANTILL, Ashbourne, Derbyshire (GB); William HEALEY, Ashbourne, Derbyshire (GB)

(21) Appl. No.: 18/869,914

(22) PCT Filed: May 31, 2023
(86) PCT No.: PCT/GB2023/051441

§ 371 Date: Nov. 27, 2024

(30) Foreign Application Priority Data
Jun. 1, 2022 (GB) 2208096.4

(51) Int. Cl. B62D 51/06; B62B 5/00

(52) U.S. Cl. CPC B62D 51/06; B62B 5/0036

(57) ABSTRACT

A load moving apparatus including: a ground engaging device configured for rotation about a substantially horizontal axis; a drive member for driving the at least one ground engaging device; a transmission member operably connected to the drive member and the ground engaging device for transmitting drive from the drive member to the ground engaging device; a chassis member which extends along an axis A for supporting the ground engaging device and the drive member, said chassis member including first and second surfaces which define outermost surfaces of the chassis member and which are spaced a first radial distance from the axis A; wherein the drive member extends a second radial distance from the axis A; wherein the second radial distance is greater than the first radial distance.

### INTRODUCTION

Embodiments of the present invention relate to a load moving apparatus. More particularly, this invention relates to a load moving apparatus for use by a pedestrian.

### BACKGROUND

Load moving apparatus are used to assist a user with moving large or heavy goods. Such apparatus typically include a ground engaging wheel, or set of wheels, which may or may not be connected to a source of power. To move a load, such apparatus are typically configured to engage with a load such that the load may be pushed or pulled.

Embodiments of the present invention seek to alleviate one or more problems associated with the prior art.

### BRIEF DESCRIPTION OF THE INVENTION

According to a first aspect of the invention we provide a load moving apparatus including:
a ground engaging device configured for rotation about a substantially horizontal axis;
a drive member for driving the at least one ground engaging device;
a transmission member operably connected to the drive member and the ground engaging device for transmitting drive from the drive member to the ground engaging device;
a chassis member which extends along an axis A for supporting the ground engaging device and the drive member, said chassis member including first and second surfaces which define outermost surfaces of the chassis member and which are spaced a first radial distance from the axis A;
wherein the drive member extends a second radial distance from the axis A;
wherein the second radial distance is greater than the first radial distance.

The chassis member may include a third surface which extends between the first and second surfaces.

The chassis member may include a fourth surface which extends between the first and second surfaces.

The first and second surfaces may include respective first and second edges which extend generally parallel to the axis A.

The third surface may extend between respective first edges of the first and second surfaces.

The fourth surface may extend between the respective second edges of the first and second surfaces.

The fourth surface may be positioned generally opposite the third surface.

The axis A may be positioned generally centrally between the first, second, third and fourth surfaces.

The chassis member may have a substantially constant cross-section.

The cross-section of the chassis member may be substantially quadrangular.

The cross-section of the chassis member may be substantially square.

The chassis member may be substantially linear.

The chassis member may include first and second ends.

The ground engaging device may be positioned close to or adjacent the first end.

The first end of the chassis member may include a first recess for receipt of at least a portion the transmission member.

The load moving apparatus may include a weight receiving portion for fixing a weight member thereto, said weight receiving portion being fixed to the first surface and extending in a direction away from the second surface.

The weight receiving portion may extend in a direction parallel to the axis A along the first surface.

The weight receiving portion may be substantially planar.

The load moving apparatus may include a castor wheel assembly receiving portion for fixing a further wheel assembly thereto, said castor wheel assembly receiving portion being fixed to the second surface and extending in a direction away from the first surface.

The castor wheel assembly receiving portion may have substantially the same cross section as the chassis member.

The castor wheel assembly receiving portion may extend in a direction generally parallel to a ground surface which the ground engaging device engages in use.

The load moving apparatus may include a load engaging device for engagement with a load to be moved.

The chassis member may include a load engaging device receiving portion for fixing the load engaging device relative to the chassis member.

The load engaging device receiving portion may be positioned generally adjacent the drive member on the first surface.

The load engaging device receiving portion may extend onto the third and fourth surfaces.

The load moving apparatus may include a handle fixed to the chassis member.

The drive member may be an electric motor.

The ground engaging device may be a wheel assembly.

The axis A may lie on a substantially vertical plane X and the chassis member may include a left and a right portion.

The plane X may be positioned between the left portion and the right portion of the chassis member.

The third surface may be positioned in the left portion of the chassis member.

The fourth surface may be positioned in the right portion of the chassis member.

The load moving apparatus may include a further ground engaging device.

The ground engaging device may be positioned adjacent the left portion of the chassis member.

The further ground engaging device may be positioned adjacent the right portion of the chassis member.

The load moving apparatus may include a further drive member drivingly connected to the further ground engaging device.

The drive member may be positioned adjacent the left portion of the chassis member.

The further drive member may be positioned adjacent the right portion of the chassis member.

The load moving apparatus may include a further transmission member operably connected to the further drive member and the further ground engaging device for transmitting drive from the further drive member to the further ground engaging device.

The transmission member may be positioned adjacent the left portion of the chassis member.

The further transmission member may be positioned adjacent the right portion of the chassis member.

The first recess may be positioned in the left portion of the chassis member.

The load moving apparatus may further include a second recess for receipt of the further transmission member positioned in the right portion of the chassis member.

The load moving apparatus may include an attachment member for attaching the at least one transmission member to the chassis member.

In a first configuration of the apparatus the attachment member may be attached to the chassis member.

In a second configuration of the apparatus the attachment member may be detached from the chassis member.

The load moving apparatus may include a further attachment member.

The attachment member may be positioned on the left portion of the chassis member.

The transmission member may be receivable at least partially by the attachment member.

The further attachment member may be positioned on the second lateral side.

The further transmission member may be receivable at least partially by the further attachment member.

In the first configuration the attachment member and the further attachment member may be attached to the chassis member.

In the second configuration the attachment member and the further attachment member may be detached from the chassis member.

In use, the main body may be inclined at an angle to a surface.

The load moving apparatus may include a user graspable handle.

The main body may includes first and second respective ends, the first end being positioned closer to a surface in use than the second end.

The ground engaging device may be positioned at the first end.

The user graspable handle may be positioned at the second end.

The load moving apparatus may include a castor wheel assembly.

The castor wheel assembly may be positioned rearwardly of the first end and under the second end.

According to a second aspect of the invention we provide a load moving apparatus including: a ground engaging device configured for rotation about a substantially horizontal axis; a drive member for driving the at least one ground engaging device;
a weight member;
a chassis member which extends along an axis A for supporting the ground engaging device and the drive member, said chassis member including first and second surfaces which define outermost surfaces of the chassis member and which are spaced a first radial distance from the axis A;
wherein the weight member extends a second radial distance from the axis A;
wherein the second radial distance is greater than the first radial distance.

The load moving apparatus according to the second aspect of the invention may include one or more or all the features of the load moving apparatus according to the first aspect of the invention.

According to a third aspect of the invention we provide a chassis for use in a load moving apparatus according to the first and/or second aspects of the invention.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a perspective view of a load moving apparatus for use by a pedestrian in accordance with the present disclosure;

FIG. 2 is a rear view of a portion of the load moving apparatus of FIG. 1 with a housing of the apparatus removed;

FIG. 3 is a perspective view of a chassis member for a load moving apparatus in accordance with the present disclosure;

FIG. 4 is a side view of the chassis member of FIG. 3;

FIG. 5 is a cross-sectional view of the chassis member of FIG. 3;

FIG. 6 is a further side view of the chassis member of FIG. 3;

FIG. 7 is a side view of the chassis member of FIG. 3 with an attachment member attached;

FIG. 8 is a perspective view of the chassis member of FIG. 7;

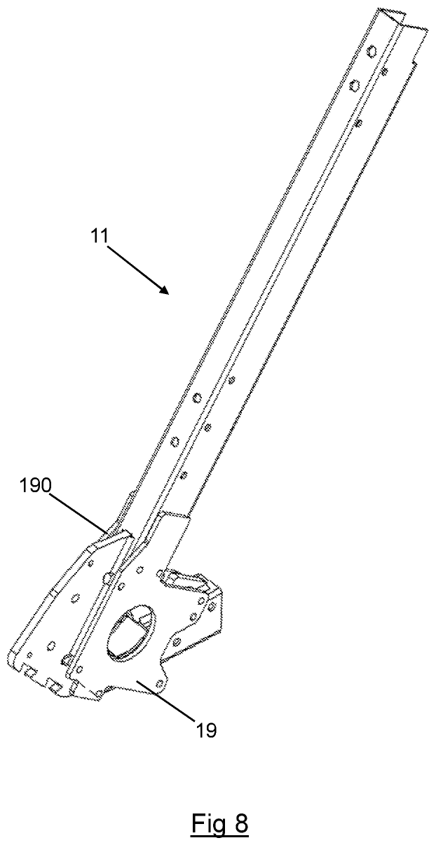

FIG. 9 is a side view of the chassis member of FIG. 7 with a weight member attached;

FIG. 10 is a side view of the chassis member of FIG. 9 with a transmission member and drive member attached in a first configuration;

FIG. 11 is a perspective view of the chassis member of FIG. 10;

FIG. 12 is a perspective view of the chassis member of FIG. 3 with a transmission member and drive member attached in a second configuration;

FIG. 13 is a side view of the chassis member of FIG. 10 with a castor wheel assembly attached;

FIG. 14 is a side view of the chassis member of FIG. 13 with a part of a load engagement device attached;

FIG. 15 is a side view of the chassis member of FIG. 14 with a hydraulic pump attached;

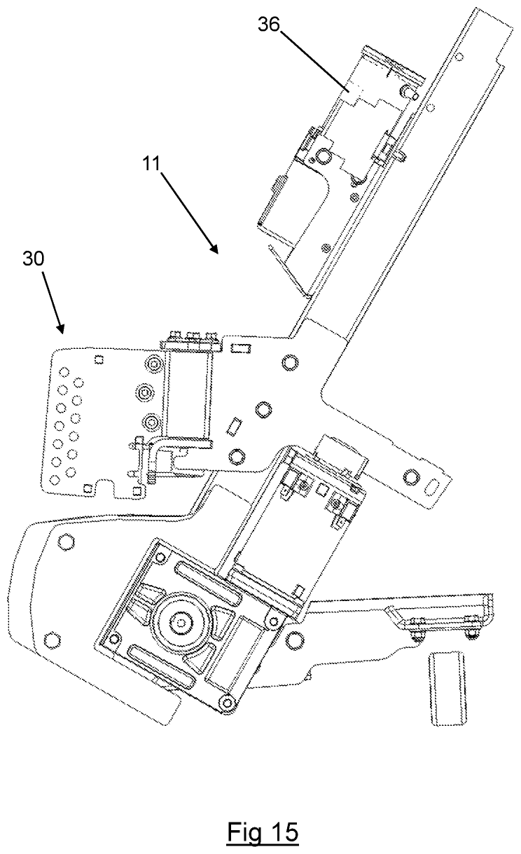

FIG. 16 is a side view of the chassis member of FIG. 15 with a user graspable handle attached;

FIG. 17 is a side view of the chassis member of FIG. 16 with a power receptacle attached;

FIG. 18 is a perspective view of the chassis member of FIG. 17 with a ground engaging device removed;

FIG. 19 is a perspective view of the chassis member of FIG. 12 with a ground engaging device, a load engagement device, a user graspable handle, a castor wheel assembly, a power receptacle and a hydraulic pump attached; and

FIG. 20 is a perspective view of the chassis member of FIG. 12 with a ground engaging device, a load engagement device, a user graspable handle, a castor wheel assembly, a power receptacle and a cable-actuated actuator attached.

### DETAILED DESCRIPTION OF THE DISCLOSURE

Referring to the figures there is provided a load moving apparatus 10 for use by a pedestrian in accordance with the present disclosure. The load moving apparatus 10 includes a main body 12, a chassis member 11, at least one ground engaging device 14, at least one drive member 16 and at least one transmission member 18. In embodiments, the apparatus 10 also includes at least one weight member 20, a load engagement device 30, a user graspable handle 40, a castor wheel assembly 50 and a power receptacle 60. These are described in more detail below.

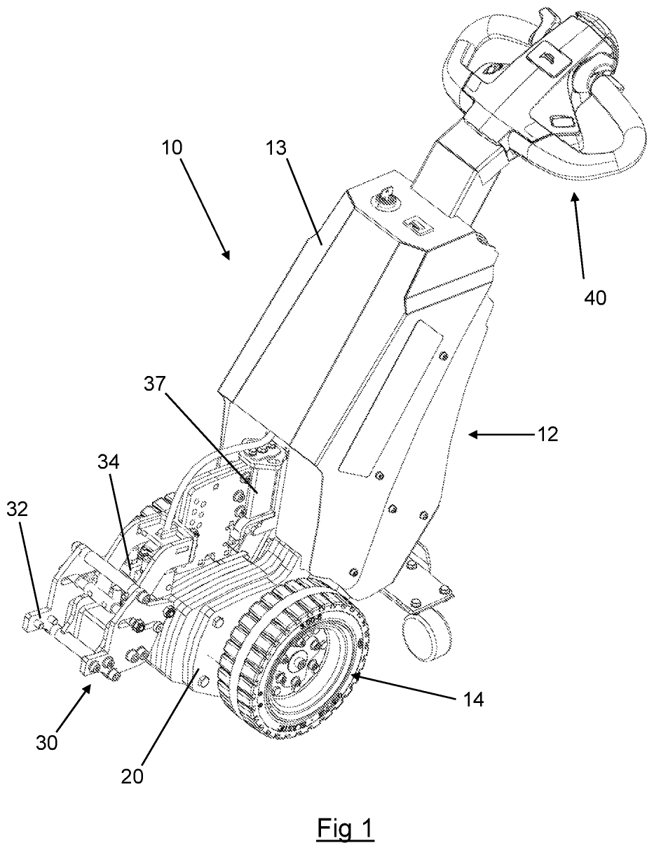

The main body 12 supports a plurality of components of the apparatus 10. In embodiments, and as shown in FIG. 1, the main body 12 may support or otherwise include a housing 13 which, in use, at least partially covers components of the apparatus 10. The housing 13 may be releasably attached to the main body 12 to allow access to the components of the apparatus 10 for the purposes of repair and servicing.

In the present embodiment, the main body 12 includes a chassis member 11 which, in use, may act as a spine member for the apparatus 10. The chassis member 11 may be configured to receive or otherwise support components of the apparatus 10.

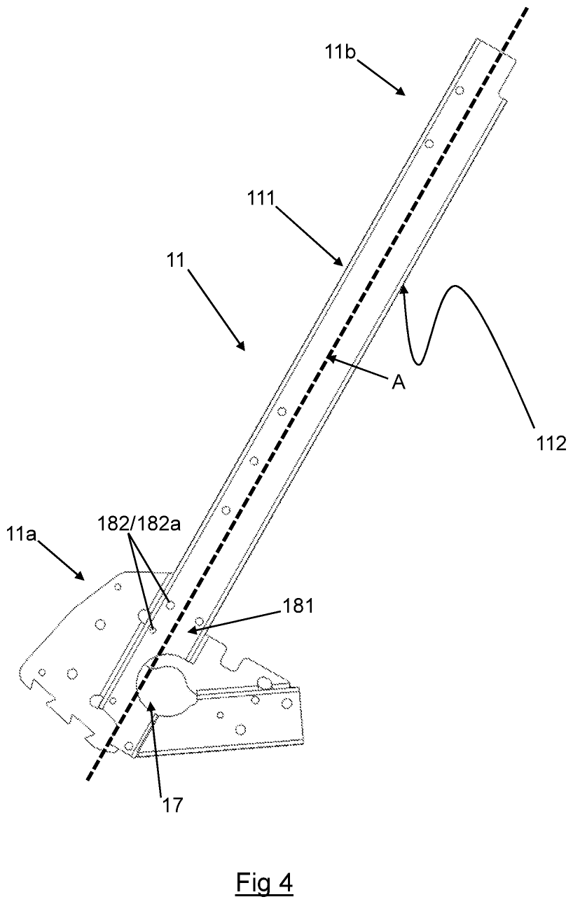

As shown in FIG. 4, the chassis member 11 may extend along an axis A between a first end 11a and a second end 11b. The axis A may lie on a substantially vertical plane X. The chassis member 11 may be inclined relative to a surface (e.g., the ground) when the apparatus 10 is in use. The chassis member 11 may extend in a direction away from one or more or all of: the at least one ground engaging device 14; the at least one drive member 16; the at least one transmission member 18; the at least one weight member; the load engagement device 30; and the castor wheel assembly 50. The castor wheel assembly 50 may be positioned substantially underneath the chassis member 11 and rearwardly of the ground engaging device 14, as described in more detail below.

The main body 12 may be inclined relative to a surface (e.g., the ground) when the apparatus 10 is in use. In embodiments, the chassis member 11 and/or the main body 12 may be oriented substantially parallel to, or perpendicular to, a surface over which the apparatus 10 is resting upon or moving across when the apparatus 10 is in use.

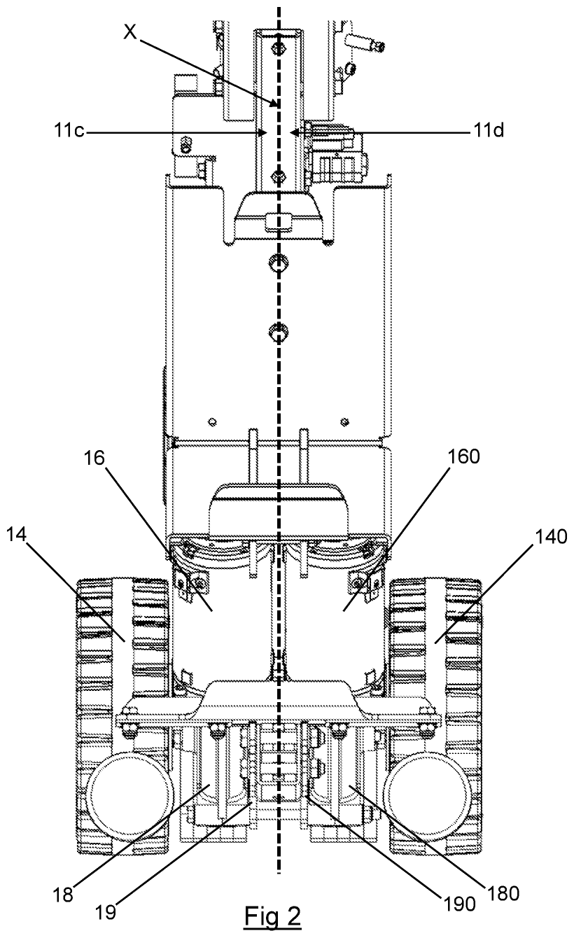

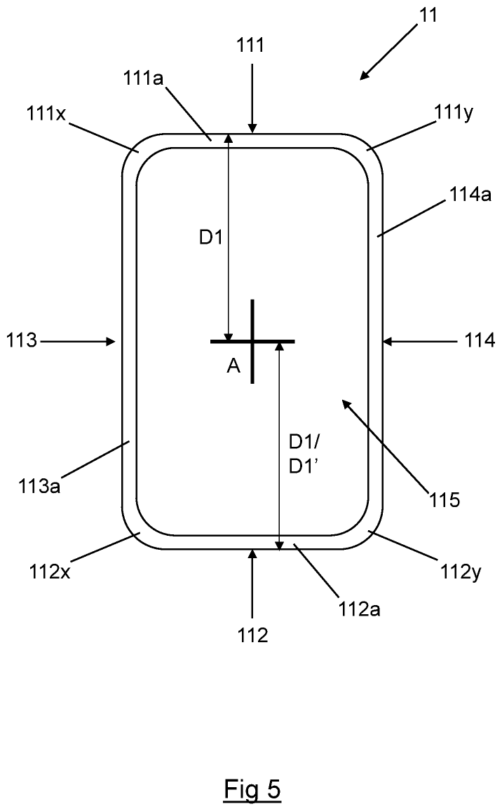

Chassis member 11 includes a first surface 111 and a second surface 112. In the present embodiment, the chassis member 11 is formed as a single component. In embodiments, chassis member 11 may be formed of a plurality of portions. For example, the chassis member 11 may include a first portion 111a, a second portion 112a, a third portion 113a and a fourth portion 114a (as shown in FIG. 5). In embodiments, the surfaces of the chassis member 11 may be on the portions 111a, 112a, 113a, 114a, as described in more detail below. As shown in FIG. 2, the chassis member 11 may have a left portion 11c generally arranged on one side of the vertical plane X and a right portion 11d generally opposing the left portion 11c and generally arranged on the opposite side of the vertical plane X. The first surface 111 and second surface 112 are positioned on opposite sides of the axis A. The first surface 111 and second surface 112 may be intersected by the vertical plane X. As seen in FIG. 5, the first surface 111 and second surface 112 are each spaced a first radial, or lateral, distance D1 from the axis A, and each surface defines an outermost surface of the chassis member 11. By this we mean that no other part of the chassis member 11 extends beyond these surfaces in the radial direction from axis A of the chassis member 11. In embodiments, the first and second surfaces 111, 112 of the chassis member 11 are substantially planar. In embodiments, the second surface 112 may be spaced a second radial distance D1′ from the axis A, the second radial distance D1′ being different to the first radial distance D1.

As mentioned above, in embodiments, and as shown in FIG. 5, the chassis member 11 may further include a third portion 113a having a third surface 113. The third portion 113a and/or the third surface 113 extend between the first surface 111 and second surface 112. In embodiments, the first surface 111 may include a first edge 111x and a second edge 111y. The first surface 111 may extend generally parallel to axis A. The second surface 112 may include a first edge 112x and a second edge 112y. The second surface 112 may extend generally parallel to axis A. The third surface 113 may extend generally parallel to the axis A. In embodiments, the third surface 113 may extend between the respective first edges 111x, 112x of the first and second surfaces 111, 112. However, it should be appreciated that in other embodiments, the third surface 113 may extend between the first and second surfaces 111, 112 but may not extend between the first edges 111x, 112x. For example, the third surface 113 may extend between the first and second portions 111, 112 from a position between the edges 111x, 112x.

As mentioned above, in embodiments, and as shown in FIG. 5, the chassis member 11 may further include a fourth portion 114a having a fourth surface 114. The fourth portion 114a and/or fourth surface 114 may extend between the first surface 111 and second surface 112. The fourth surface 114 may extend generally parallel to the axis A. In embodiments, the fourth surface 114 may extend between the respective second edges 111y, 112y of the first and second surfaces 111, 112. Similar to the third surface 113, it should be appreciated that in other embodiments, the fourth surface 114 may extend between the first and second surfaces 111, 112 but may not extend between the second edges 111y, 112y. For example, the fourth surface 114 may extend between the first and second portions 111, 112 from a position between the edges 111y, 112y.

In embodiments, and as shown in FIG. 5, the first surface 111 may be positioned generally opposite the second surface 112. The third surface 113 may be positioned in the left portion 11c of the chassis member 11. The fourth surface 114 may be positioned in the right portion 11d of the chassis member 11. The third and fourth surfaces 113, 114 may be generally opposite. The third and fourth surfaces 113, 114 may define an outermost surface of the chassis member 11. The axis A of the chassis member 11 may be positioned generally centrally between the first surface 111 and second surface 112, and/or the third surface 113 and fourth surface 114. In use of the apparatus 10, the first surface 111 may define a substantially upwardly and forwardly facing surface, the second surface 112 may define a substantially downwardly and rearwardly facing surface. The third surface 113 may define a substantially leftward facing surface and the fourth surface 114 may define a substantially rightward facing surface.

As mentioned above, in the present embodiment, the portions of the chassis member 11 are formed integrally, such that the chassis member 11 may be formed as one piece. In embodiments, the chassis member 11 may include a plurality of portions, as explained above. In embodiments, the chassis member may be formed by extrusion, casting, welding, or any other appropriate process.

In embodiments, the chassis member 11 may be substantially constant in cross-section, in particular as the chassis member 11 extends along the axis A. In embodiments the cross-section may be substantially quadrangular, square or rectangular. The cross-section may be defined at least partially by the first and/or second and/or third and/or fourth portions 111a, 112, 113a, 114a. As shown in FIG. 5, the cross-section may be substantially quadrangular, and the corners of the quadrangular cross-section may be radiused. In embodiments, the corners of the quadrangular cross-section may be chamfered or shaped in other ways.

In embodiments, the chassis member 11 may include only two or three outermost surfaces and the cross-section may be substantially triangular. In embodiments, the cross-section may be substantially H-shaped or U-shaped.

In embodiments, the chassis member 11 may extend along the axis A such that it is substantially linear in shape, meaning that the outermost surfaces of the chassis member 11 are a constant distance from the axis A as the chassis member 11 extends along the axis A. In embodiments, the surfaces 111, 112, 113, 114 may be substantially planar surfaces. In embodiments, the chassis member 11, or the portions of the chassis member 11, may define an internal space 115 which extends at least partially along the axis A. In other words, at least a portion of the chassis member 11 may be substantially hollow. The cross-section of the internal space 115, i.e., the internal cross-section of the chassis member 11, may be substantially similar in shape to the outermost cross-section of the chassis member 11. In embodiments, they may differ.

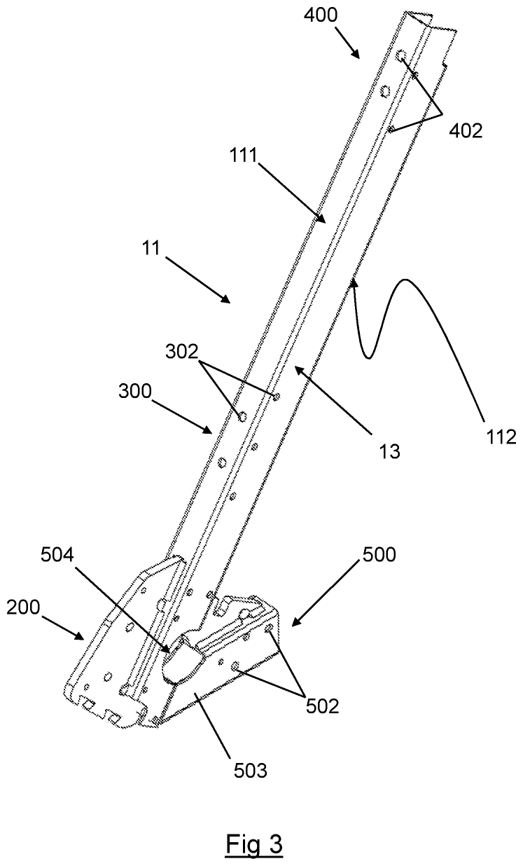

In embodiments, and as shown in FIG. 3, the apparatus 10 may include a plurality of receiving portions which may be configured to receive or otherwise support components of the apparatus 10. The receiving portions may be provided directly on the chassis member 11 or may be attached, connected or otherwise provided on the chassis member 11. In embodiments, the receiving portions may include at least one receiving formation. In embodiments, the at least one receiving formation may be an aperture. The aperture may be formed on the respective receiving portion by any appropriate manufacturing process, including but not limited to laser cutting, plasma cutting, water jet cutting, milling, drilling, stamping or punching.

In the present embodiment, the apparatus 10 includes at least one ground engaging device 14. In embodiments, the at least one ground engaging device 14 may be a wheel assembly including a wheel which, in use, rotates about a substantially horizontal axis and contacts a ground surface. The at least one ground engaging device 14 may be positioned at or close to the first end 11a of the chassis member 11. The ground engaging device 14 may be operably connected to a transmission member 18. In embodiments, the transmission member 18 may be a gearbox. In embodiments, the transmission member 18 may be a right-angle gearbox comprising a worm gear mechanism. The apparatus 10 may also include a drive member 16, which is operably connected to the transmission member 18 such that drive may be transmitted from the drive member 16 to the ground engaging device 14. In embodiments, the drive member 16 may be an electric motor. In embodiments, the transmission member 18 may at least partially support the drive member 16 relative to the chassis member 11 and may provide the connection between the ground engaging device 14 and the chassis member 11, such that the ground engaging device 14 may at least partially support the apparatus 10 above a ground surface.

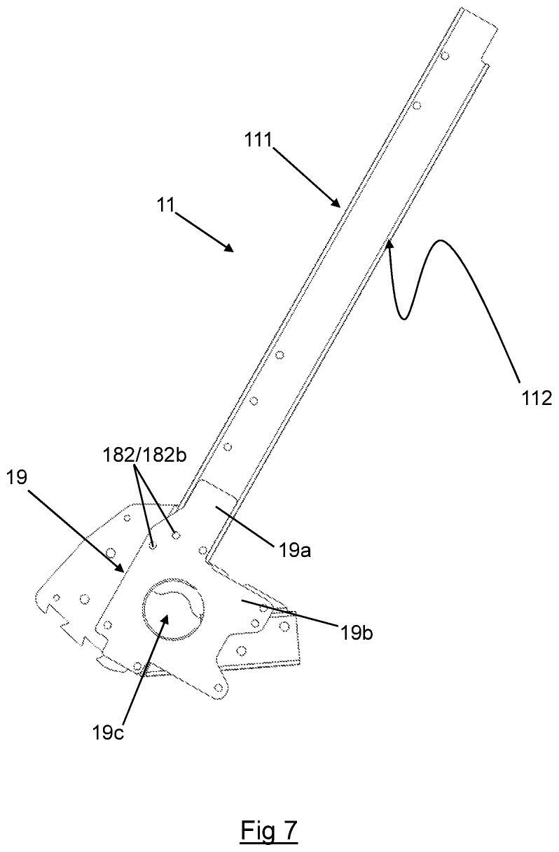

In embodiments, and as shown in FIG. 4, the chassis member 11 may include a first recess 17 for receipt of at least a portion of the transmission member 18. As shown in FIG. 7, the chassis 11 may also include an attachment member 19 for attaching the transmission member 18, such that the transmission member 18 may be supported on or by an outermost surface 111, 112, 113, 114 of the chassis member 11. The attachment member 19 may be provided, attached, fixed or otherwise connected to a remainder of the chassis member 11. In the present embodiment the attachment member 19 is attached to the third portion or surface 113. In embodiments, the attachment member 19 may be attached to the first portion or surface 111, second portion or surface 112 or the fourth portion or surface 114. The attachment member 19 may be substantially planar. In embodiments, and as shown in FIG. 7, the attachment member 19 may include at least a first portion 19a and a second portion 19b. In use, the first portion 19a may extend in a direction which is substantially parallel to axis A of the chassis member 11. The second portion 19b may extend substantially inclined, or substantially perpendicular, relative to the first portion 19a. The second portion 19b may extend in a direction towards the second surface 112 of the chassis member 11 and parallel to the substantially vertical plane B. In embodiments, the attachment member 19 may also include a recess 19c for receipt of a portion of a transmission member 18, described in more detail below.

The chassis member 11 may also include at least one transmission member receiving portion 181 for receiving at least a portion of the transmission member 18 and/or for receiving at least a portion of the attachment member 19. The transmission member receiving portion 181 may include at least one receiving formation 182 for receiving at least a portion of the transmission member 18 and/or the attachment member 19. In embodiments, the receiving formation 182 may comprise at least one aperture for receiving a fastener, which may or may not be at least partially threaded.

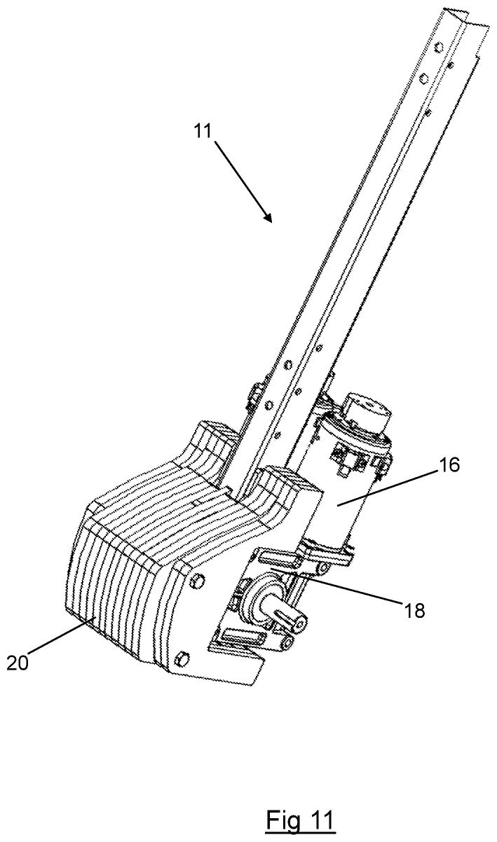

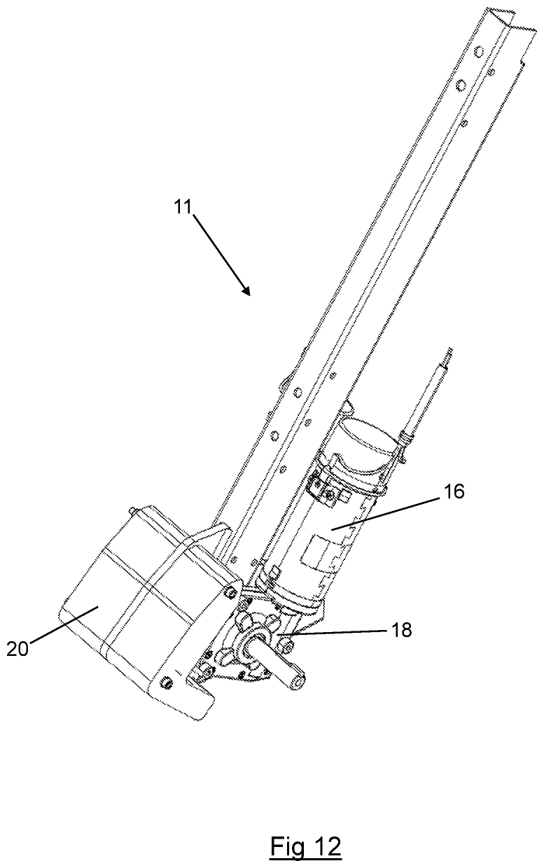

In embodiments, the receiving portion 181 and receiving formation 182 may be arranged such that the apparatus 10 is configured to adopt either of first or second respective configurations for the production of first or second apparatus 10, where the first apparatus is different to the second apparatus. In the first configuration, and as shown in FIG. 11, the transmission member 18 may be received by the attachment member 19, and the attachment member 19 may be received by the receiving portion 181. In the first configuration, the transmission member 18 may be received by the first recess 17 provided on the chassis member 11, and the recess 19c provided on the attachment member 19. In the second configuration, and as shown in FIG. 12, the transmission member 18 is received by the first recess 17 and/or the receiving portion 181, and no attachment member 19 is provided. In embodiments, the receiving portion 181 may comprise a plurality of receiving formations 182, as shown in FIG. 4. In embodiments, the receiving portion 181 may be configured such that the same plurality of formations 182 are used when the apparatus 10 is in the first and second configuration. In other embodiments, the plurality of receiving formations 182 may comprise a first plurality of receiving formations 182a and a second plurality of receiving formations 182b, with the first 182a plurality of receiving formations being used in the first configuration and the second plurality of receiving formations 182b being used in the second configuration.

Advantageously, the possible arrangements of the first recess 17, receiving portion 181, receiving formation(s) 182 and attachment member 19 enable different apparatus 10 to be constructed. In one example, the same transmission member 18 may be used between different apparatus, but the use of the attachment member 19 in only one of the configurations means that the transmission member 18 may be spaced further away from the axis A relative to the other configuration. In another example, a different transmission member 18 may be used which enables the use of different size or configurations of ground engaging devices 14 and drive members 16 to be supported by the chassis member 11. The provision of the first recess 17, receiving portion 181, receiving formation(s) 182 and attachment member 19 thus enable different configurations of apparatus to be formed using optimal components without requiring modifications to be made to the chassis member 11. Therefore, the apparatus can be formed such that it operates at an optimal efficiency, with low power consumption, and the chassis member 11 does not require energy intensive modifications to accommodate different types of components.

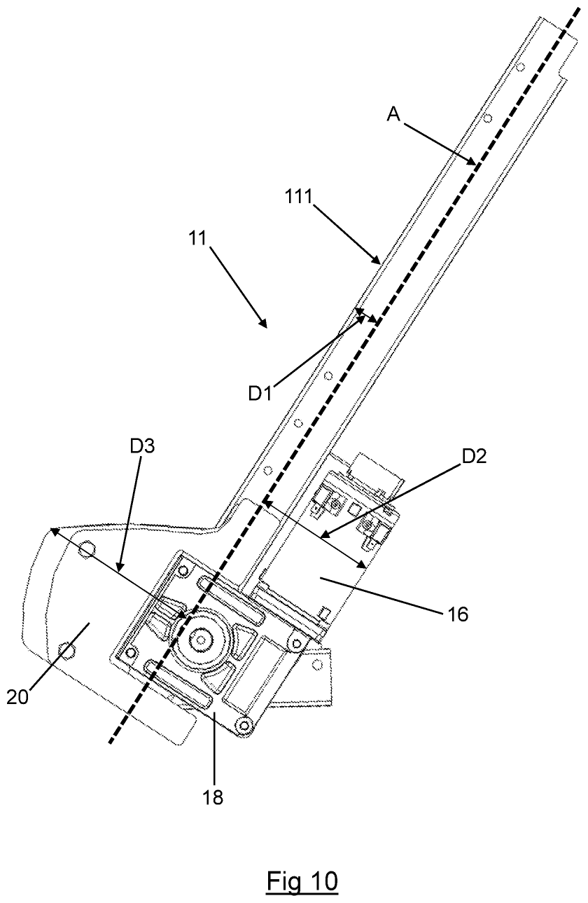

As shown in FIGS. 2, 10, 11 and 12, an effect of this arrangement of the ground engaging device 14, the drive member 16 and the transmission member 18 is that all of these components may be positioned outwardly of outermost surfaces 111, 112, 113, 114 of the chassis member 11 with respect to the axis A of the chassis member 11. As shown in particular in FIG. 10, the drive member 16 extends radially from the axis A such that it extends a second radial distance D2 from the axis A. In the present embodiment, the second radial distance D2 is greater than the first radial distance D1. In embodiments the second radial distance D2 may be equal to or less than the first radial distance D1. Advantageously, as the chassis member 11 is configured such that all of these components are positioned externally of the outermost surfaces 111, 112, 113, 114 of the chassis member 11 (i.e., they surround the chassis member 11), and a compact arrangement of these components about the chassis member 11 can be achieved. In addition, the overall size, volume and mass of the chassis member 11 with respect to the apparatus 10 is hence optimised to be compact whilst still allowing for all necessary and auxiliary components of the apparatus 10 to be supported on or by the chassis member 11. In addition, different components can be easily fitted to the same base chassis member 11 to form different apparatus, e.g., where weight members 20, transmission members 18, drive members 16 and load engagement device 30 may differ. Therefore, the manufacture of different apparatus 10 is greatly simplified by sharing a common chassis member 11. The use of such a chassis member 11 has also significantly reduced the number of welding operations required to form the chassis for the load moving apparatus whilst also improving the manufacturing tolerance of the chassis. Therefore, this has improved manufacturing efficiency and accuracy.

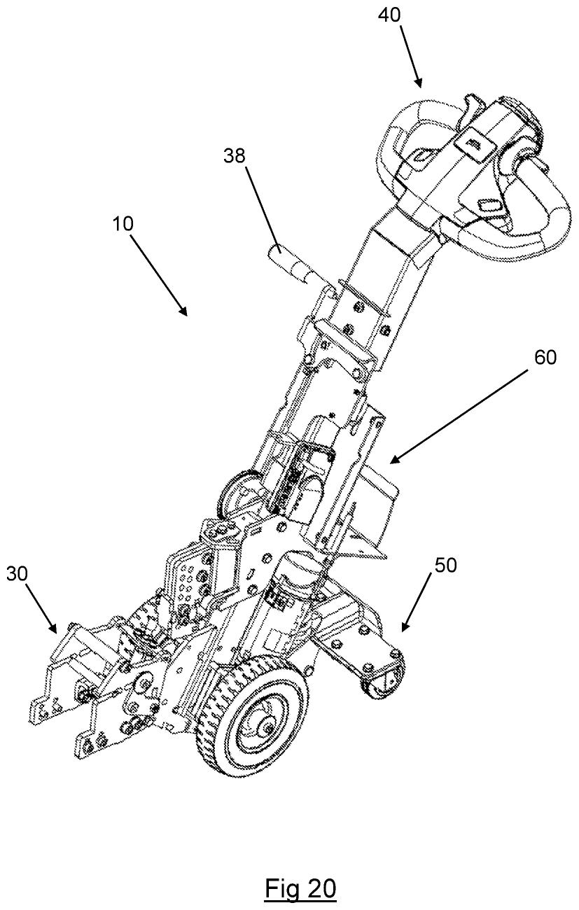

In embodiments, and as shown in FIG. 20, the apparatus 10 may include a further ground engaging device 140, a further drive member 160 and a further transmission member 180. In embodiments, the further ground engaging device 140, a further drive member 160 and a further transmission member 180 may be operably connected in a similar or substantially identical manner in which the ground engaging device 14, drive member 16 and transmission member 18 are operably connected. In embodiments, a first recess 17 and first receiving portion 181 may provided on the left portion 11a of the chassis member 11 and a second recess (not shown) and second receiving portion (not shown) for receipt of the further transmission member 180 may be provided on the right portion 11b of the chassis member 11. In embodiments, attachment member 19 may be provided for supporting the transmission member 18 on the left portion 11a and a further attachment member 190 may be provided for supporting the further transmission member 180 on the right portion 11b. This arrangement means that the transmission members 18, 180 and operably connected components are positioned generally symmetrically on opposite sides of the axis A and the vertical plane X, with the transmission member 18 positioned adjacent the left portion 11c of the chassis member 11 and the further transmission member 180 positioned adjacent the right portion 11d of the chassis member 11.

As shown in the figures, the chassis member 11 provides for a particularly compact and symmetrical arrangement of ground engaging devices 14, 140, drive members 16, 160 and transmission member 18, 180 about the axis A, whilst ensuring that the chassis member 11 is optimally configured for size, volume and mass.

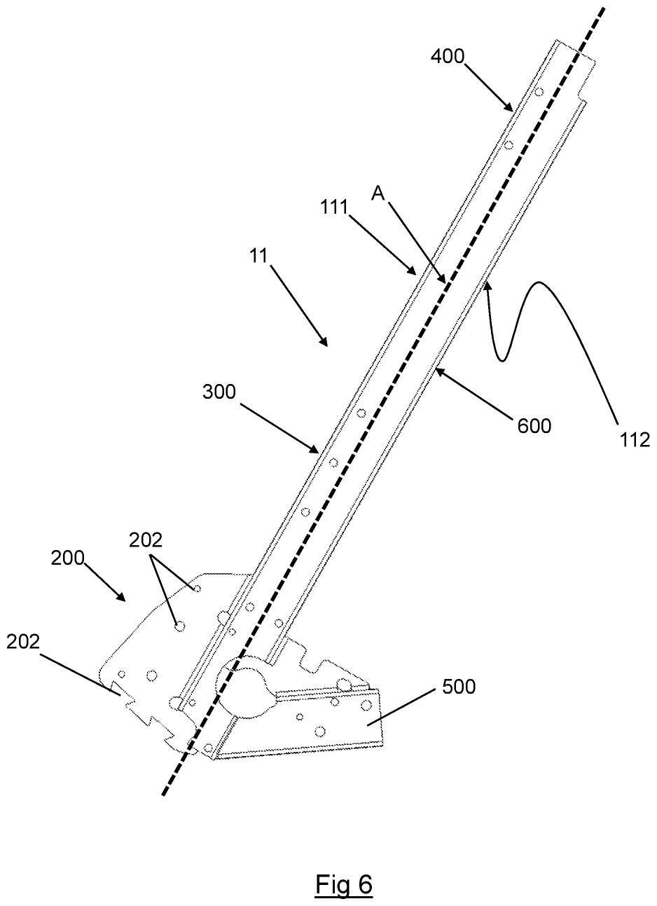

In embodiments, and as shown in FIG. 6, the apparatus 10 may further include a weight member receiving portion 200 for fixing a weight member 20 thereto. The weight receiving portion 200 may be fixed to, connected to or otherwise provided on the first surface 111, and extends away in a direction away from the second surface 112. In embodiments, the weight receiving portion 200 may also extend along the first surface 111 and away from the second surface 112 in a direction which is parallel to the substantially vertical axis A. As shown in the figures, the weight receiving portion 200 may be substantially planar, though it should be appreciated that in other embodiments the weight receiving portion 200 may not be substantially planar.

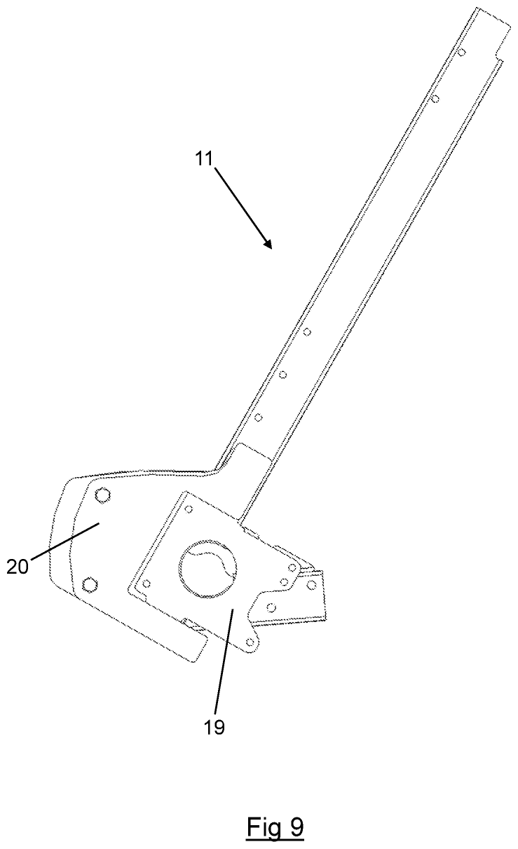

In use, a weight member 20 may be fixed to the weight receiving portion 200, as shown in FIGS. 9 to 12. The weight member receiving portion 200 may include at least one receiving formation 202 which facilitates fixing the weight member 20 to the weight receiving portion 200. When the weight member 20 is fixed or otherwise supported by the receiving portion 200, the weight member 20 extends a third radial distance D3 from the axis A of the chassis member 11, as shown in FIG. 10. In the present embodiment, the third radial distance D3 is greater than the first radial distance D1 and/or the second radial distance D2. In embodiments, the third radial distance D3 may be substantially equal to the first and/or second radial distance D1, D2. In embodiments, the third radial distance D3 may be less than the first radial distance D1 and/or the second radial distance D2.

In embodiments, the receiving formation 202 may comprise at least one aperture for receiving a fastener. The aperture may be configured to allow a fastener, e.g. a bolt, to pass through the aperture, or it may be at least partially threaded such that it can engage with a part of a fastener. In embodiments, the receiving formation 202 may also, or alternatively, comprise a shaped formation which engages with a complementary formation provided on the weight member 20. In embodiments, and as shown in FIGS. 11 and 12, the weight receiving portion 200 may receive different configurations of weight members 20, which may vary by mass, shape and/or volume. As shown in the figures, the weight receiving portion 200 enables a weight member 20 to be fixed to the chassis member 11 such that the weight member 20 is positioned entirely external to the outermost surfaces 111, 112, 113, 114 of the chassis member 11. Advantageously, this enables the weight member 20 to be supported by the chassis member 11 close to the axis A which runs through the chassis member 11. In addition, the slim shape of the chassis member 11 provides more open volume into which a weight member 20 may be positioned, so that the weight distribution and energy efficiency of the apparatus 10 may be more precisely optimised.

In embodiments, the apparatus 10 may further include a load engagement device 30 for engagement with a load to be moved. In embodiments, the load engagement device 30 may be rotatably movable with respect to the main body 12 and the chassis member 11. The chassis member 11 may include a load engagement device receiving portion 300 for fixing a load engagement device thereto. In embodiments, the load engagement device receiving portion 300 may be positioned on the first surface 111 and, in use, is positioned above the receiving portion 181 for the transmission member 18 and generally adjacent the drive member 16. In use, the load engagement device 30 is supported by the chassis member 11 such that it fixed to the first surface 111 and extends in a direction away from the second surface 112. As shown in the figures, the receiving portion 300 for the load engagement device 30 may comprise a receiving formation 302 which comprises at least one aperture which is provided on, and may extend through, the first surface 111 of the chassis member 11. In embodiments, a single aperture, or a plurality of apertures, may be provided. In embodiments, the second surface 112 of the chassis member 111 may also include a receiving formation 302 which may comprise the same number of apertures as provided on the first surface 111.

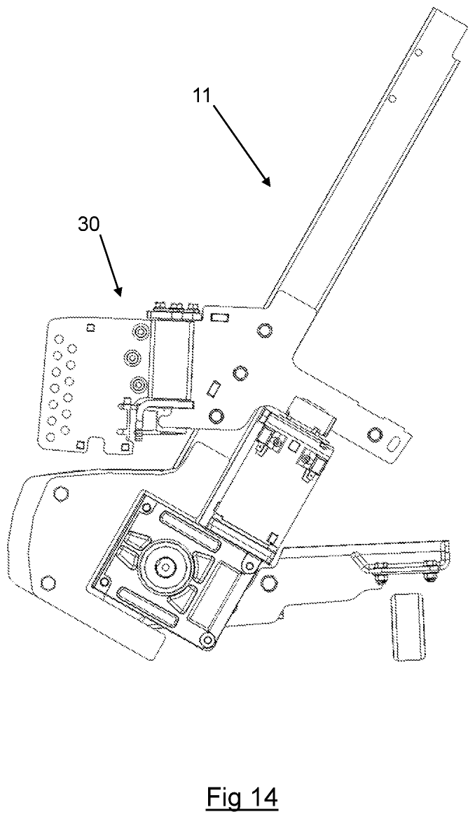

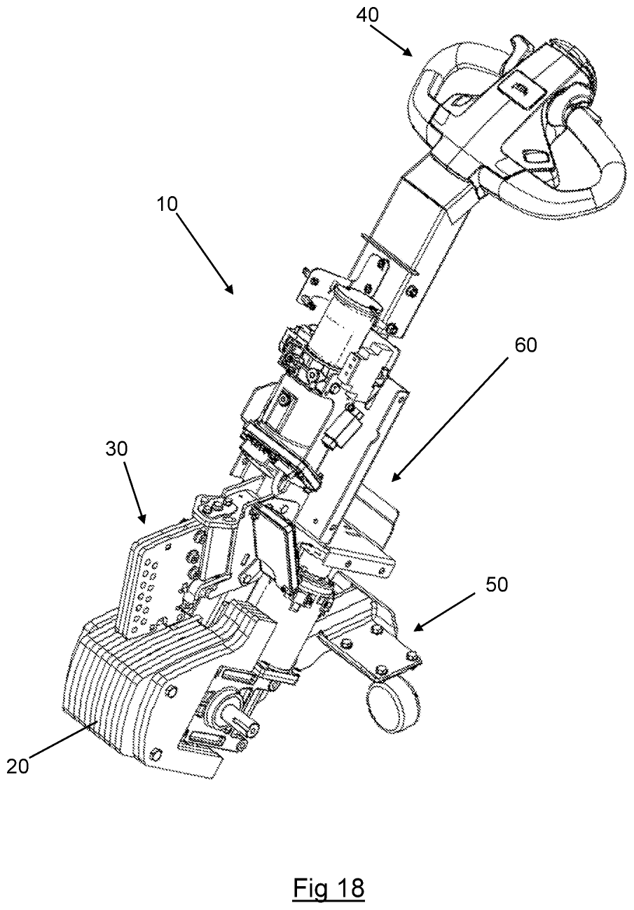

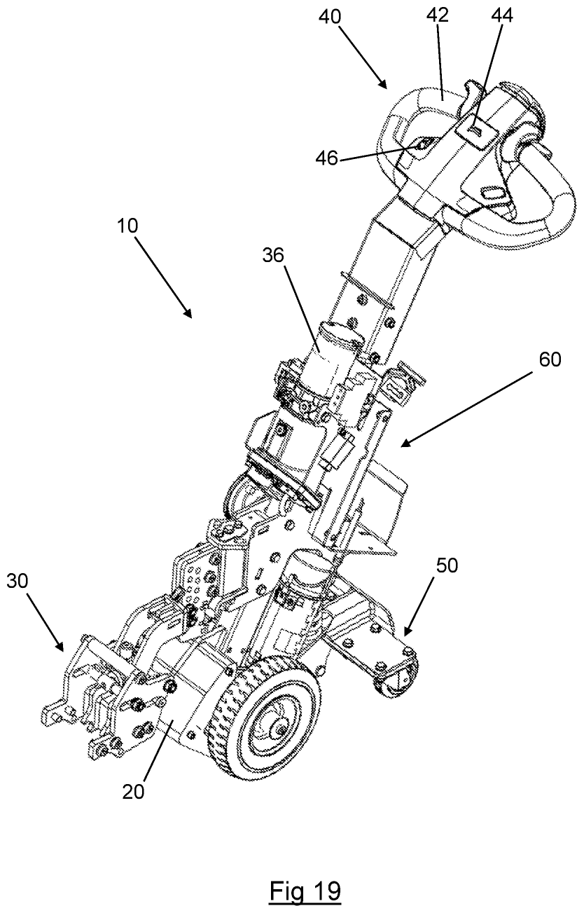

In embodiments, and as shown in FIG. 14, the load engaging device receiving portion 300 may extend onto the third and fourth surfaces 113, 114. The receiving formation 302 of the receiving portion 300 may include the apertures provided on at least the first surface 111 of the chassis member 11, and in addition may comprise at least one aperture provided on the third surface 113 of the chassis member 11. It may also comprise at least one aperture provided on the fourth surface 114 of the chassis member 11. In embodiments, each surface 113, 114 may include one aperture, or a plurality of apertures. The apertures may be configured to allow a fastener to pass through them, or they may be at least partially threaded to as to engage with a fastener. In use, the load engagement device 30 may abut with, engage with or grasp a part of a load to be moved. The load engagement device 30 may include at least one engagement member 32 which engages with or grasps a part of a load to be moved. The at least one engagement member 32 may be moveable between a first position in which the member 32 is engaged with a part of a load to be moved, and a second position in which the member 32 is disengaged from a part of a load to be moved. The at least one engagement member 32 may be operably connected to an actuation member 34, which effects the movement of the engagement member 32 between the first and second positions. The actuator member 34 may be an electrical actuator, or it may be a hydraulic actuator such as an electrohydraulic actuator, or it may be a cable-actuated actuator such as a Bowden cable type actuator. In embodiments, and as shown in FIGS. 18 and 19, the source of hydraulic power for an electrohydraulic actuator, such as a pump 36 and/or an accumulator (not shown), or a cable mechanism 38, for example a Bowden cable mechanism, for a cable-actuated actuator may be supported on or by the chassis member 11.

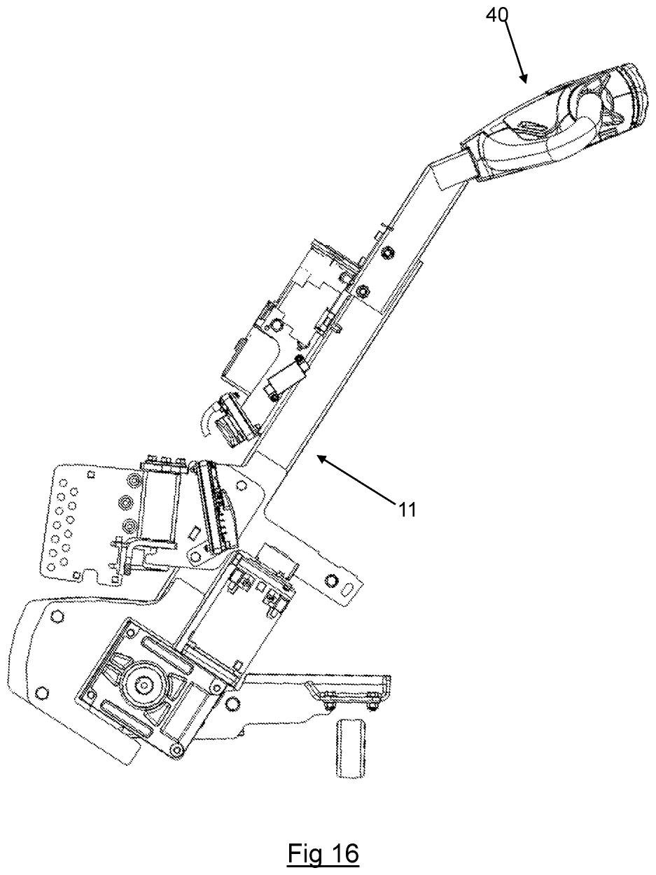

The apparatus 10 can be operated by a pedestrian. In embodiments, and as shown in FIG. 16, the apparatus 10 may include a user graspable handle 40, which may allow a pedestrian to operate the apparatus 10 for the purposes of movement and steering over a ground surface in addition to other functions such as operating other parts of the apparatus 10. The chassis member 11 may include a handle receiving portion 400 for fixing the user graspable handle 40 thereto. In embodiments, the user graspable handle 40 is positioned at or adjacent the second end 11b of the chassis member 11. The handle 40 may extend in a direction away from the first end 11a of the chassis member 11, and away from the ground engaging device 14, the drive member 16 and the transmission member 18. In use, it may be positioned above the receiving portion 181 for the transmission member 18 and above the receiving portion 300 for the load engagement device 30. In embodiments, the receiving portion 400 may comprise a receiving formation which may be provided on the first, second, third and/or fourth surfaces 111, 112, 113, 114 of the chassis member 11. The receiving formation 402 may include at least one aperture provided on the third surface 113 and/or at least aperture provided on the fourth surface 114. In embodiments, the apertures may be configured to allow a fastener to pass through them, or they may be at least partially threaded so as to engage with a fastener.

The user graspable handle 40 includes at least one user graspable part 42 at an upper free end, a portion of which may comprise a material which is comfortable for an operator to grasp, such as a rubber material, soft plastic material, or any other suitable material.

The apparatus 10 may include at least one alerting device 44, which may be operable by the operator. The at least one alerting device 44 may be positioned on the user graspable handle 40. The at least one alerting device 44 may be configured to produce an audible warning signal and/or a visual signal.

The apparatus 10 may include an operating device 46, which allows the operator to control a function of the apparatus 10, such as operation of the load engagement device 30 or any other appropriate function. The operating device 46 may be positioned on the user graspable handle 40.

In embodiments, the load moving apparatus 10 may be configured to be controlled from a remote device such that a pedestrian operator may be spaced at a distance from the apparatus 10 to move or otherwise operate the apparatus. In such embodiments, the apparatus 10 may include a user graspable handle 40 such that the operator may operate the apparatus 10 manually or remotely as desired.

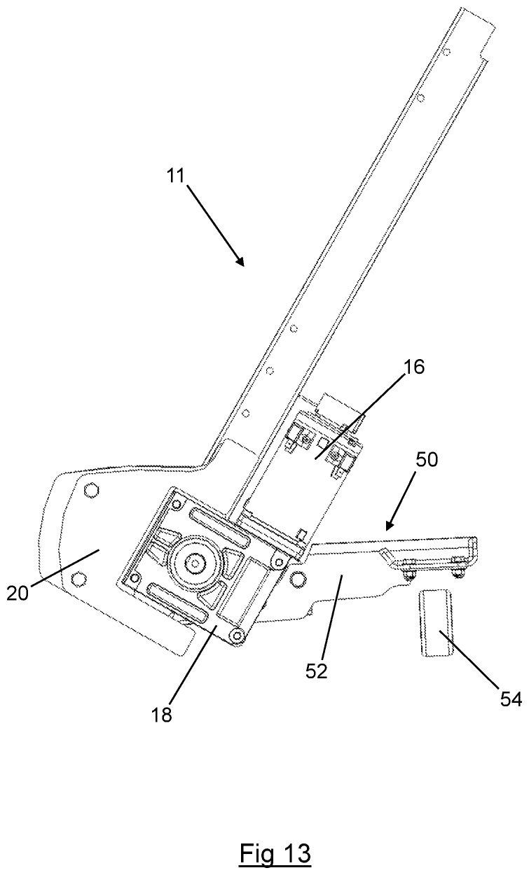

In embodiments, and as shown in FIG. 3, the apparatus 10, or chassis 11, may further include a castor wheel assembly receiving portion 500 for fixing a castor wheel assembly 50 thereto. In embodiments, the castor wheel assembly receiving portion 500 may be fixed to the second surface 112 of the chassis member 11 and may extend in a direction away from the first surface 111 of the chassis member 11. In embodiments, the castor wheel assembly receiving portion 500 may have a cross-section which is similar to, or substantially the same as, the cross-section of the chassis member 11. The cross-section of the castor wheel assembly receiving portion 500 may be constant along its length as it extends from the second surface 112 in a direction away from the first surface 111 of the chassis member 11. In use, the castor wheel assembly receiving portion 500 may extend in a direction which is generally parallel to a ground surface which the ground engaging device 14 engages with. The castor wheel assembly receiving portion 500 may comprise a receiving formation 502 which may be provided on a surface 503 of the castor wheel assembly receiving portion 500 which is parallel with the third surface 113 of the chassis member 11, and/or may comprise a receiving formation 502 which may be provided on a surface 504 of the castor wheel assembly receiving portion 500 which is parallel with the fourth surface 114 of the chassis member 11. In embodiments, the castor wheel assembly receiving portion 500 may be connected to the chassis member 11 by the use of at least one fastener. In other embodiments, it may be formed integrally with the chassis member 11. In embodiments, it may be permanently connected to the chassis member 11 by the use of welding, brazing, soldering or by the use of adhesives or any other appropriate means of permanently connecting the receiving portion 500 to the chassis member 11. In embodiments, a portion of the first recess 17 for receiving at least a portion of the transmission member 18 may be provided on the castor wheel assembly receiving portion 500. In use, the castor wheel assembly 50 may be fixed to the receiving portion 500 by the use of at least one fastener which may pass through an at least one aperture provided on the castor wheel assembly 50, as shown in FIG. 13. The at least one fastener may then pass through or engage with the receiving formation provided on the castor wheel assembly receiving portion 500. In embodiments, the connection between the castor wheel assembly 50 and the receiving portion 500 may provide for pivotable or rotational movement of the castor wheel assembly 50 with relation to the receiving portion 500, the chassis member 11 and the main body 12 between a first and second position.

In embodiments, the castor wheel assembly 50, when supported by receiving formation 500, may be positioned substantially below the user graspable handle 40, as shown in FIG. 16. The castor wheel assembly 50 may be positioned substantially below, and/or substantially to the rear of, the load engagement device 30. The castor wheel assembly 50 may be positioned substantially below, and/or substantially to the rear of, the drive member 16. The castor wheel assembly 50 may be positioned substantially to the rear of the transmission member 18 and/or the ground engaging device 14. The castor wheel assembly 50 includes a castor arm 52 and at least one castor 54 which is connected to the castor arm. The at least one castor 54 includes a wheel portion 54a which is supported by, and is rotatably moveable relative to, a mounting portion 54b. The at least one castor 54 is mounted at or close to a second end 52b of the castor arm 52 via the mounting portion 54b. The at least one castor 54 may be configured such that, in use, the mounting portion 54b is able to swivel about a substantially vertical axis whilst permitting the wheel portion 54a to rotate. The castor wheel assembly 50 may also include a castor arm biasing member 56 which, in use, urges the castor arm 52 towards the first or second position. The castor arm biasing member 56 is connected at one end to a part of the castor arm 52 and is connected to a part of the chassis member 11 or another part of the main body 12 at another end. The castor arm biasing member 56 may comprise a coil spring or any other suitable biasing mechanism.

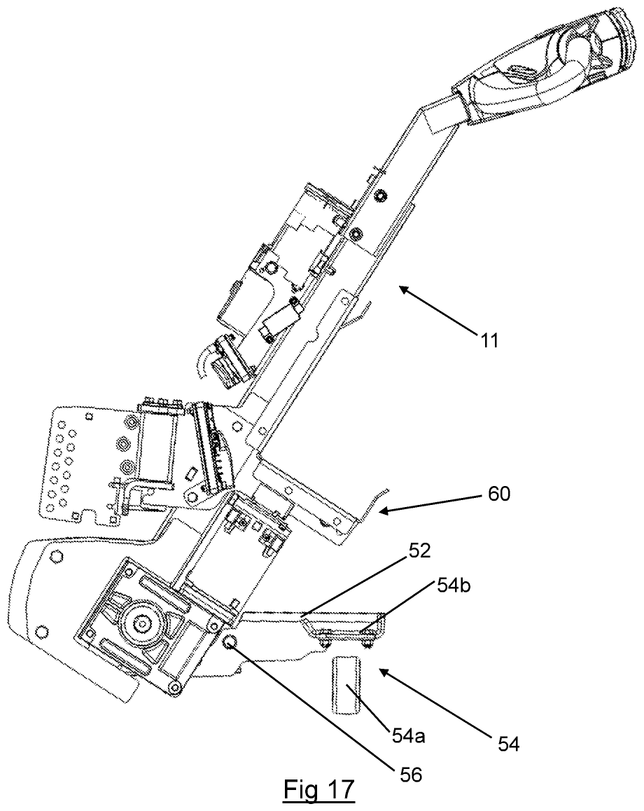

In embodiments, and as shown in FIG. 17, the apparatus 10 includes a power receptacle 60. In some embodiments, the power receptacle 60 may be a socket or port which may receive a cable from an external power source, such as a source of mains electricity or a generator. In embodiments, the power receptacle 60 may be configured to receive an insertable battery. The battery received by the receptacle 60 may be a rechargeable battery, and may be a lead acid battery, a nickel metal hydride battery, a lithium-ion battery or a nickel cadmium battery. In use, the power receptacle is operably connected to the at least one drive member 16, and may be operably connected to other components of the apparatus 10, such as devices provided on the user graspable handle 40, which require a source of power to operate. In embodiments wherein a battery is received by the power receptacle 60, the operating characteristics of the battery, such as capacity, voltage, power, energy density and type may be selected based on the requirements of the apparatus 10.

In embodiments, the power receptacle 60 may be fixed to the chassis member 11 by a power receptacle receiving portion 600. The power receptacle receiving portion 600 may be provided on any of the outermost surfaces 111, 112, 113, 114 of the chassis member 11. In the embodiment shown in the figures, it may be provided on the second surface 112 of the chassis member 11, such that, in use, it may be positioned substantially below the user graspable handle 40. It may be positioned substantially above the castor wheel assembly 50. It may be positioned substantially rearwardly of the load engagement device 30. It may be positioned substantially above, and substantially rearwardly of the drive member 16, and transmission member 18.

In embodiments, the chassis member 11 may include other receiving portions for receiving other components of the load moving apparatus 10 which have not been described in detail, such that these components are positioned externally of the outermost surfaces 111, 112, 113, 114 of the chassis member 11.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

What is claimed is:

1.-26. (canceled)

27. A load moving apparatus including:
a ground engaging device configured for rotation about a substantially horizontal axis;
a drive member for driving the at least one ground engaging device;
a transmission member operably connected to the drive member and the ground engaging device for transmitting drive from the drive member to the ground engaging device;
a chassis member which extends along an axis A for supporting the ground engaging device and the drive member, said chassis member including first and second surfaces which define outermost surfaces of the chassis member and which are spaced a first radial distance from the axis A;
wherein the drive member extends a second radial distance from the axis A;
wherein the second radial distance is greater than the first radial distance.

28. The load moving apparatus of claim 27, wherein the chassis member includes a third surface which extends between the first and second surfaces.

29. The load moving apparatus of claim 28, wherein the chassis member includes a fourth surface which extends between the first and second surfaces.

30. The load moving apparatus of claim 29, wherein the first and second surfaces include respective first and second edges which extend generally parallel to the axis A;
wherein the third surface extends between respective first edges of the first and second surfaces.

31. The load moving apparatus of claim 30, wherein the fourth surface extends between the respective second edges of the first and second surfaces; and/or
wherein the fourth surface is positioned generally opposite the third surface; and/or
wherein the axis A is positioned generally centrally between the first, second, third and fourth surfaces.

32. The load moving apparatus of claim 27, wherein the chassis member has a substantially constant cross-section;
wherein the cross-section of the chassis member is substantially quadrangular;
wherein the cross-section of the chassis member is substantially square; and/or
wherein the chassis member is substantially linear.

33. The load moving apparatus of claim 27, wherein the chassis member includes first and second ends, and wherein the ground engaging device is positioned close to or adjacent the first end;
wherein the first end of the chassis member includes a first recess for receipt of at least a portion the transmission member.

34. The load moving apparatus of claim 33 including:
a weight receiving portion for fixing a weight member thereto, said weight receiving portion being fixed to the first surface and extending in a direction away from the second surface;
wherein the weight receiving portion extends in a direction parallel to the axis A along the first surface; and/or
wherein the weight receiving portion is substantially planar; or
a castor wheel assembly receiving portion for fixing a further wheel assembly thereto, said castor wheel assembly receiving portion being fixed to the second surface and extending in a direction away from the first surface;
wherein the castor wheel assembly receiving portion has substantially the same cross section as the chassis member; and/or
wherein the castor wheel assembly receiving portion extends in a direction generally parallel to a ground surface which the ground engaging device engages in use.

35. The load moving apparatus of claim 29 including a load engaging device for engagement with a load to be moved;
wherein the chassis member includes a load engaging device receiving portion for fixing the load engaging device relative to the chassis member.

36. The load moving apparatus of claim 35 wherein the load engaging device receiving portion is positioned generally adjacent the drive member on the first surface; or
wherein the load engaging device receiving portion extends onto the third and fourth surfaces.

37. The load moving apparatus of claim 27 including a handle fixed to the chassis member; and/or
wherein the drive member is an electric motor; and/or
wherein the ground engaging device is a wheel assembly.

38. The load moving apparatus of claim 30 wherein the axis A lies on a substantially vertical plane X and the chassis member includes a left and a right portion;
wherein the plane X is positioned between the left portion and the right portion of the chassis member; and
wherein the third surface is positioned in the left portion of the chassis member and the fourth surface is positioned in the right portion of the chassis member.

39. The load moving apparatus of claim 38 further including:
a further ground engaging device, wherein the ground engaging device is positioned adjacent the left portion of the chassis member and the further ground engaging device is positioned adjacent the right portion of the chassis member; and
a further drive member drivingly connected to the further ground engaging device, wherein the drive member is positioned adjacent the left portion of the chassis member and the further drive member is positioned adjacent the right portion of the chassis member.

40. The load moving apparatus of claim 39 including a further transmission member operably connected to the further drive member and the further ground engaging device for transmitting drive from the further drive member to the further ground engaging device, wherein the transmission member is positioned adjacent the left portion of the chassis member and the further transmission member is positioned adjacent the right portion of the chassis member.

41. The load moving apparatus of claim 40 wherein the chassis member includes first and second ends, and wherein the ground engaging device is positioned close to or adjacent the first end;
wherein the first end of the chassis member includes a first recess for receipt of at least a portion the transmission member,
wherein the first recess is positioned in the left portion of the chassis member; and
further including a second recess for receipt of the further transmission member positioned in the right portion of the chassis member.

42. The load moving apparatus of claim 40 including:
an attachment member for attaching the at least one transmission member to the chassis member;
wherein in a first configuration of the apparatus the attachment member is attached to the chassis member; and
wherein in a second configuration of the apparatus the attachment member is detached from the chassis member; and
a further attachment member;
wherein the attachment member is positioned on the left portion of the chassis member, wherein the transmission member is receivable at least partially by attachment member;
wherein the further attachment member is positioned on the second lateral side, wherein the further transmission member is receivable at least partially by the further attachment member;
wherein in the first configuration the attachment member and the further attachment member are attached to the chassis member; and
wherein in the second configuration the attachment member and the further attachment member are detached from the chassis member.

43. The load moving apparatus of claim 27 wherein in use, the main body is inclined at an angle to a surface;
wherein the load moving apparatus includes a user graspable handle;
wherein the main body includes first and second respective ends, the first end being positioned closer to a surface in use than the second end;
wherein the ground engaging device is positioned at the first end; and
wherein the user graspable handle is positioned at the second end;
wherein the load moving apparatus includes a castor wheel assembly;
wherein the castor wheel assembly is positioned rearwardly of the first end and under the second end.

44. A load moving apparatus including:
a ground engaging device configured for rotation about a substantially horizontal axis;
a drive member for driving the at least one ground engaging device;
a weight member;
a chassis member which extends along an axis A for supporting the ground engaging device and the drive member, said chassis member including first and second surfaces which define outermost surfaces of the chassis member and which are spaced a first radial distance from the axis A;
wherein the weight member extends a second radial distance from the axis A;
wherein the second radial distance is greater than the first radial distance.

45. The load moving apparatus of claim 44 including a transmission member operably connected to the drive member and the ground engaging device for transmitting drive from the drive member to the ground engaging device.

46. A chassis for use in the load moving apparatus of claim 27.
